(19) United States
(12) Patent Application Publication
(10) Pub. No.: US 2008/0148793 A1
(43) Pub. Date: Jun. 26, 2008

(54) Locking device

(76) Inventors: Ming Liang Steven Shiao, Anaheim, CA (US); Franklin Minnath, Marietta, GA (US)

Correspondence Address: David L. Bell, Esq.;Suite B 507, 2110 Artesia Blvd., Redondo Beach, CA, 90278, US

(21) Appl. No.: 11/159,860

(22) Filed: Jun. 23, 2005

(51) Int. Cl. E05B 15/16

(52) U.S. Cl. 70/417

(57) ABSTRACT

A locking device for an enclosure, such as a vending machine, wherein the locking device includes an extension capable of receiving and cooperating with a lock at either/or both ends of the extension. The locking device is designed to prevent vandalism to the enclosure.

### FIELD OF THE INVENTION

The present invention relates generally to locking devices to secure enclosures such as vending machines.

### BACKGROUND

A man was purportedly asked why he robbed banks. His reply was direct, “because that is where the money is”. For much the same reason, machines used in the vending machine industry have been under constant attack from theft and vandalism. First, the machines were padlocked to provide security. The locks were easy to break so the venders used stronger locks. When the locks became too hard to easily break, the thieves began attacking other parts of the lock assembly. What is needed is a lock design that successfully deters any vandalism while still allowing the goods contained in the vending machines to be easily accessible to consumers.

Several approaches have been tried to protect vending machines used to sell newspapers. Early newspaper racks were not even closed and a metal tube was used to hold the coins. Payment was based on the honor system. The honor system failed and more secure locking devices were required. Newspapers were then placed in enclosed stands and padlocked. Vandals rose to the challenge and easily broke the locks off. The padlock was modified by being attached to a metal rod having the padlock at one end and a plug at the other. The plug was slightly larger in circumference than the rod. So the plug end held the bar secure at one end and the padlock held the rod secure at the other end. Again, vandals rose to the occasion. Shielding was placed around the lock with much the same result.

The locking device was modified again to place a plug lock at one end of the rod and placing the other end within the coin housing. Soon, vandals were again able to break through the protection.

One method of protecting such a vending machine is disclosed in U.S. Pat. No. 4,049,106 (the '106 patent) issued to Chalabian. This provided a housing for protecting a coin sorting and control mechanism and a coin storage box for use with a vending machine, such as a newspaper stand. The housing included a body for a coin sorting and control mechanism and a vending machine door latch to lock the door. A cover that fit closely over its top enclosed the body. The cover and body were provided with heavy steel flanges through which a padlock can be passed to lock them together. This device became a standard in the industry and vandals yet again arose to the occasion.

Therefore, what is needed is a method of protecting newspaper magazines and their contents in a inexpensive and effective manner. Therefore, the goal of the present invention is to economically and efficiently protect vending machines.

### SUMMARY

It is an object of the present invention to protect a vending machine and vending machine lock from vandalism. Some embodiments of the invention provide a device for the protection of vending machines from vandalism by providing a stronger locking mechanism. In some instances, the lock will protect a vending machine that is designed to hold newspapers and the like. For some embodiments, it is the object of the present invention to protect vending machines from attack by providing a locking device having a tubular member with an enlarged proximate end, angled holes for setscrews and a shackle hole at the proximate end

In accordance with these objects and with others that will be described and which will become apparent, an exemplary embodiment of a locking device in accordance with the present invention is described herein. While the most commonly used application is expected to be the protection of vending machines, the invention may be used on any enclosure that requires a padlock. Thus, both vending machines and other enclosures will simply be referred to as “enclosures”.

### BRIEF DESCRIPTION OF THE DRAWINGS

The novel features of the invention are set forth in the appended claims. However, for purpose of explanation, several embodiments of the invention are set forth in the following figures.

FIG. 1 is a side elevation showing in cross section

FIG. 2 shows an enclosure with the locking device cooperating with the enclosure via-a-vis a coin box.

### DETAILED DESCRIPTION

In the following description, for the purposes of explanation, specific component arrangements and constructions and other details are set forth in order to provide a more thorough understanding of the present invention. It will be apparent to those skilled in the art, however, that the present invention may be practiced without these specific details. In other instances, well known manufacturing methods and structures have not been described in detail so as to refrain from obscuring the present invention unnecessarily.

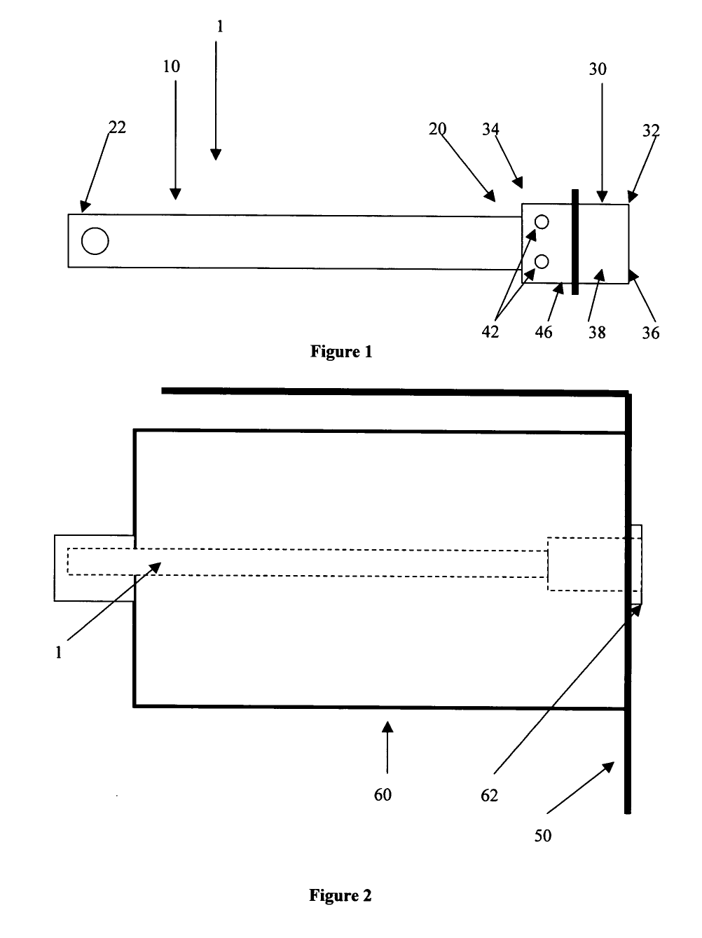

Referring first to FIG. 1, some embodiments of the invention provide for a locking mechanism for vending machines. In one embodiment, the locking mechanism 1 comprises a cylinder 10 having a proximate end 20 and a distal end 22. The circumference of the cylinder 10 at the proximate end 20 of the cylinder 10 is enlarged sufficiently to allow the emplacement of a locking device 40. This portion of the cylinder 10 is called the cylinder lock housing 30. It also has a proximate 32 and a distal end 34, a threaded interior surface 36 and an exterior surface 38. These aforementioned and other items cooperate together to form a locking device 1 designed to protect the coin box 60 of the vending machine from attack.

The '106 Patent to Chalabian provides a description of an enclosure typically used to protect newspapers (FIG. 1) as well as a description of a coin box (FIG. 5). One embodiment of the present invention 1 is designed to fit into and through a coin box of an enclosure such as described in FIG. 5 of the '106 Patent.

Referring next to FIG. 2, the coin box housing 60 of vending machine enclosure 50 is shown. The coin box housing includes a sheath 62 around an opening. The opening passes through and to the opposite of the housing 60. The sheath 62 cooperates with the hole in the coin box housing 60 to form a tight fit with the exterior wall of the coin box housing 60. When the locking mechanism 1 is inserted into and through the hole of the coin box housing 60, the locking mechanism 1 cooperates with the coin box housing 60 and the sheath 62 to form a tight fit wherein the proximal end of the cylinder lock housing 32 fits flush against the exterior surface of the sheath 62.

Referring now to both FIG. 1 and FIG. 2, the locking mechanism 1 comprises the cylinder lock housing 30, a cylinder 10 permanently affixed to the distal end of the cylinder lock housing 34 and a hole 24 at the proximate end of the cylinder 10. The cylinder lock housing 30 includes a threaded interior surface 36 and an exterior surface 38. The interior surface 36 of the cylinder lock housing 30 is threaded so as to accept a lock, such as a plug lock. A plug lock is designed to screw into the threaded interior opening of the cylinder lock housing 30 and to cooperate with the threaded interior surface 36 such as to prevent the lock from being pulled out of the cylinder lock housing 34 when set screws are engaged to cooperate with the cylinder lock housing 30 and the plug lock.

Located on the exterior surface 38 of the cylinder lock housing 30 is a gasket 46. When the locking mechanism 1 is installed and operational, the gasket 46 is flush with the exterior surface of the coin box housing sheath 62. Also located on the exterior surface 38 of the cylinder lock housing 10 are openings 42 that pass from the exterior surface 38 to the interior surface 36. The openings 42 are positioned such that they are located between the gasket 46and the distal end of the cylinder lock housing 34. When the locking mechanism 1 is installed and fully cooperating with the coin box housing 60, the openings 42 are positioned within the interior of the coin box housing 60. In one embodiment of the present invention, the openings 42 are slanted such that the opening on the exterior surface 38 is closer to the distal end 34 of the cylinder than the openings on the interior surface 36. The positioning of the openings 42 in this manner prevents vandals from prying in between the sheath 62 and the plug lock to unscrew the setscrews placed in the openings 42 to secure the plug lock in place.

The distal end of the cylinder 22 includes a shackle hole 24. The shackle hole allows the passage of a padlock shackle through the hole 22. When the locking mechanism 1 is installed and fully cooperating with the coin box housing 60, the padlock is secure against the distal end of the coin box housing 50 and is further protected by a coin box housing sheath (not shown). At the other end, the cylinder lock housing 10 rests firmly within, and flush with, the coin box housing sheath 62. Further, locking mechanism 1 is installed and fully cooperating with the coin box housing 60, the plug lock is cooperating with the threaded interior surface 36, the set screws, the coin box housing sheath 62, and the set screw openings 42, to prevent the unauthorized removal of the lock.

While the invention has been described with reference to numerous specific details, one of ordinary skill in the art will recognize that the invention can be embodied in other specific forms without departing from the spirit of the invention. Thus, one of ordinary skill in the art would understand that the invention is not to be limited by the foregoing illustrative details, but rather is to be defined by the appended claims.

What is claimed and sought by way of Letters of Patent is:

1. A locking mechanism designed to protect an enclosure, comprising:
a) a lock housing unit capable of receiving a lock,
b) said lock housing unit permanently affixed to an extension having one dimension longer than any other dimension of the extension;
i) said longer dimension having a distal end and a proximal end;
ii) said extension having a hole passing through the distal end of the extension; and
iii) said hole capable of receiving a lock shackle.

2. The invention of claim 1 wherein the extension is a cylinder.

3. The invention of claim 1 wherein the lock housing unit comprises;
a. a distal end and a proximal end;
b. an opening at the proximal end comprising a threaded interior surface; and
c. an exterior surface wherein said exterior surface comprises a plurality of threaded openings capable of receiving setscrews.

4. The invention of claim 3 wherein said lock is a plug lock.

5. The invention of claim 4 wherein said plurality of openings are slanted with each opening of the plurality of threaded openings is paired with another opening such that the two openings are the first and second ends of a hole going from the exterior surface of the lock housing unit to the interior surface of the lock housing unit.

6. The invention of claim 5 wherein the holes are slanted with the opening to the exterior surface located closer to the distal end of the lock housing unit than the opening of the interior surface.

7. The invention of claim 6 further comprising a gasket cooperating with the exterior surface of the lock housing unit and located between the holes and the proximal end of the lock housing unit.

8. A method of creating a locking mechanism designed to protect an enclosure wherein said method comprises the steps of;
a. Creating a locking device comprising;
1) a lock housing unit capable of receiving a lock,
2) said lock housing unit permanently affixed to an extension having one dimension longer than any other dimension of the extension;
i) said longer dimension having a distal end and a proximal end;
ii) said extension having a hole passing through the distal end of the extension; and
iii) said hole capable of receiving a lock shackle.

9. The invention of claim 8 wherein the extension is a cylinder

10. The invention of claim 9 wherein the lock housing unit comprises;
a. a distal end and a proximal end;
b. an opening at the proximal end comprising a threaded interior surface; and
c. an exterior surface wherein said exterior surface comprises a plurality of threaded openings capable of receiving setscrews.

11. The invention of claim 10 wherein said lock is a plug lock.

12. The invention of claim 11 wherein said plurality of openings are slanted with each opening of the plurality of threaded openings is paired with another opening such that the two openings are the first and second ends of a hole going from the exterior surface of the lock housing unit to the interior surface of the lock housing unit.

13. The invention of claim 12 wherein the holes are slanted with the opening to the exterior surface located closer to the distal end of the lock housing unit than the opening of the interior surface.

14. The invention of claim 13 further comprising a gasket cooperating with the exterior surface of the lock housing unit and located between the holes and the proximal end of the lock housing unit.
